(19) United States
(12) Patent Application Publication
(10) Pub. No.: US 2025/0020243 A1
(43) Pub. Date: Jan. 16, 2025

(54) Flexible Multi-Tube Retainer

(71) Applicant: Illinois Tool Works Inc., Glenview, IL (US)

(72) Inventor: Kileean E. Bell, Monee, IL (US)

(21) Appl. No.: 18/766,769

(22) Filed: Jul. 9, 2024

Related U.S. Application Data
(60) Provisional application No. 63/526,036, filed on Jul. 11, 2023.

(51) Int. Cl. F16L 3/223; F16L 3/12; F16L 3/237

(52) U.S. Cl. CPC F16L 3/2235; F16L 3/12; F16L 3/237

(57) ABSTRACT

Described is a tube retainer for securing a tube relative to a component. The tube retainer includes a carrier portion and a fastener portion. The carrier portion secures the tube via a tube pocket. The tube pocket comprises a first set of flexible arms and/or a second set of flexible arms. The fastener portion defines a central longitudinal axis. The fastener portion is configured to engage the component via an opening.

### RELATED APPLICATION

The present application claims priority to U.S. Provisional Patent Application No. 63/526,036, filed Jul. 11, 2023, and entitled “Flexible Multi-Tube Retainer,” which is hereby incorporated by reference in its entirety.

### BACKGROUND

Vehicular (e.g., automotive) components require attachment and fastening techniques that are simple to manufacture and assemble. In many instances, objects need to be securely fastened to the vehicle to prevent movement or shifting during operation, which can cause damage, kinking, or rattling. For example, tubes, hoses, wires, and other conduits are often secured to vehicle components using tube retainers.

Fastening techniques for attaching tube retainers must be reliable and efficient. In some cases, the tube retainer can be secured to the vehicle through a panel opening or by engaging a stud. Therefore, the tube retainer may include either a stud fastener feature to engage a stud associated with a vehicular component or a panel fastener feature to engage a panel opening associated with the vehicular component. However, this often requires end-users to stock different types and sizes of fasteners in their inventory to address both studs and panel openings as well as various tube sizes.

Therefore, despite advancements to date, it would be highly desirable to have a fastener that is configured to engage various tube sizes.

### SUMMARY

The present disclosure relates generally to a fastening system to form a connection between two components, such as vehicular components and tubes (or other objects), using a fastener that can secure various tube sizes, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIGS. 1a and 1b illustrate a fastening system configured to secure one or more tubes relative to a component having an opening formed therein via a tube retainer in accordance with an aspect of this disclosure.

FIGS. 2a and 2b illustrate, respectively, topside isometric views of the tube retainer of FIGS. 1a and 1b in an open position and a closed position.

FIGS. 2c and 2d illustrate, respectively, side elevation views a first side of the tube retainer in the open position and the closed position.

FIGS. 2e and 2f illustrate, respectively, side elevation views of a third side and a fourth side of tube retainer in the closed position.

FIGS. 2g and 2h illustrate, respectively, top plan and bottom plan views of the tube retainer.

FIG. 2i illustrates a detailed view of a tube pocket of the tube retainer.

FIGS. 3a through 3f illustrate additional fastener styles suitable for coupling the carrier portion with the component in accordance with other aspects of this disclosure.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

A tube retainer can be used to couple an object to a component, such as a tube to a vehicular component. Typical tube retention features hold the tube firmly, accommodating a small range of tube diameters without negatively affecting retention and sliding force. In contrast, flexible retaining systems often fail to hold the tube securely, resulting in poor retention and sliding force. The disclosed retainer, however, allows for a wide range of tube sizes. The cam interference can be precisely tuned to provide consistent force across a large range of tube diameters, ensuring effective retention and reliable sliding force.

The disclosed tube retainer is configured to retain multiple tube diameters and incorporates several novel features to ensure versatility and secure attachment. The tube retainer is specifically engineered to accommodate and hold tubes of varying diameters, making it highly adaptable. The tube retainer can be produced via injection molding or 3D printing applications, ensuring ease of manufacturing. The tube retainer is flexible, allowing it to securely retain multiple diameters. The retainer comprises one or more sets of retaining features, for example, one set on the carrier body and another on the cover. Additionally, a hinge can be created between the carrier body and cover (e.g., lid) to enhance flexibility during tube assembly. The flexible arms are configured to interfere with each other or with the sides of the lid and carrier body, or both, creating a cam-like force on the tube retainer. This interference generates a force on the tube, increasing the sliding force and ensuring a secure hold.

In one example, a tube retainer for securing a tube relative to a component comprises: a carrier portion configured to secure the tube via a tube pocket, wherein the tube pocket comprises a first set of flexible arms; and a fastener portion defining a central longitudinal axis, wherein the fastener portion is configured to engage the component via an opening.

In another example, a tube retainer for securing a tube relative to a component comprises: a carrier portion configured to secure the tube via a tube pocket, wherein the tube pocket comprises a first set of flexible arms and a second set of flexible arms; and a fastener portion defining a central longitudinal axis, wherein the fastener portion is configured to engage the component via an opening.

In yet another example, a tube retainer for securing a tube relative to a component comprises: a carrier portion configured to secure the tube via a tube pocket, wherein the carrier portion comprises a carrier body and a lid coupled to the carrier body via a hinge, and wherein the tube pocket comprises a first set of flexible arms positioned on the carrier body and a second set of flexible arms positioned on the lid; and a fastener portion defining a central longitudinal axis, wherein the fastener portion is configured to engage the component via an opening.

In some examples, the first set of flexible arms comprises two inward-curving arms.

In some examples, the two inward-curving arms are configured to flex towards and away from one another.

In some examples, the first set of flexible arms defines a C-shaped cross-section.

In some examples, the tube pocket comprises a second set of flexible arms.

In some examples, the carrier portion comprises a carrier body and a lid coupled to the carrier body via a hinge.

In some examples, the first set of flexible arms is positioned on the carrier body and a second set of flexible arms is positioned on the lid.

In some examples, the carrier portion comprises a second set of flexible arms opposite the first set of flexible arms.

In some examples, the carrier portion and the fastener portion are fabricated as a unitary structure.

In some examples, the carrier body, the lid, and the hinge are fabricated as a unitary structure.

In some examples, the lid comprises a snap configured to engage a corresponding feature formed in or on the carrier body.

In some examples, the snap comprises a button configured to disengage the snap from the corresponding feature.

In some examples, the carrier portion includes a carrier body that defines one or more windows.

In some examples, the fastener portion comprises a plurality of fins distributed along the central longitudinal axis to define a fin tier.

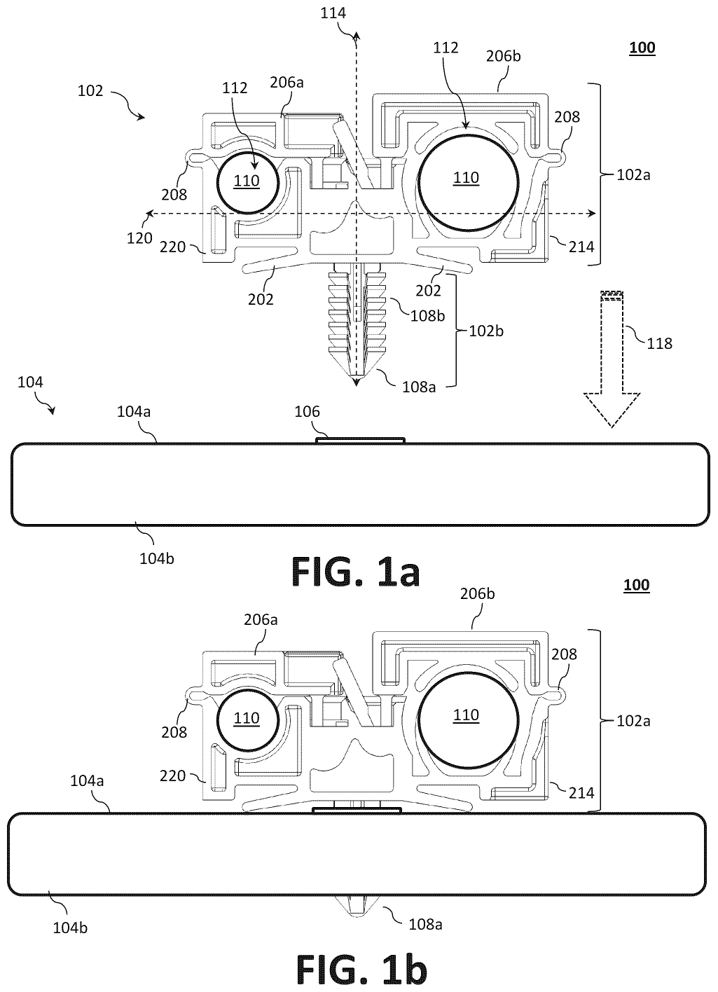

FIGS. 1a and 1b illustrate a fastening system 100 in accordance with an aspect of this disclosure, configured to secure one or more tubes 110 relative to a component 104 having an opening 106 therein via a tube retainer 102. The one or more tubes 110 may be, for example, brake lines, fuel lines, wires, cables (e.g., electric cables), pipes, or any other tubular structure that may be secured to a component 104. In the illustrated example, the tube retainer 102 is configured to retain tubes 110 of different diameters. While the tube retainer 102 will be described primarily as a tube retainer configured to attach tubes 110, it can be used to attach other objects and components.

The component 104 defines an A-side surface 104a (e.g., a first surface, such as an exterior surface) and a B-side surface 104b (e.g., a second surface, such as an interior surface). The one or more tubes 110 are illustrated as being secured to or on the A-side surface 104a. The component 104 may be, for example, an automotive panel, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like. Depending on the application, the component 104 may be fabricated from metal (or a metal alloy), synthetic or semi-synthetic polymers (e.g., plastics, such as acrylonitrile butadiene styrene (ABS) and polyvinyl chloride (PVC), etc.), composite materials (e.g., fiberglass), or a combination thereof.

The component 104 may include, define, or otherwise provide the opening 106, which may be formed during manufacturing of the component 104 or attached during assembly. During installation, the fastener portion 102b of the tube retainer 102 is inserted into the opening 106 formed in or on a surface of the component 104, as indicated by arrow 118, such that the panel-retention features engage the opening 106 (e.g., the perimeter of the component 104 that defines the opening). In some examples, the tube retainer 102 may comprise a seal to mitigate dust, dirt, and/or moisture penetration through the opening 106. The seal may be embodied as a ring (e.g., an annulus) and fabricated from foam material, thermoplastic, rubber, etc. For example, a seal can be configured to fit over the distal end of the tube retainer 102 to surround a portion of the fastener portion 102b (e.g., the shank).

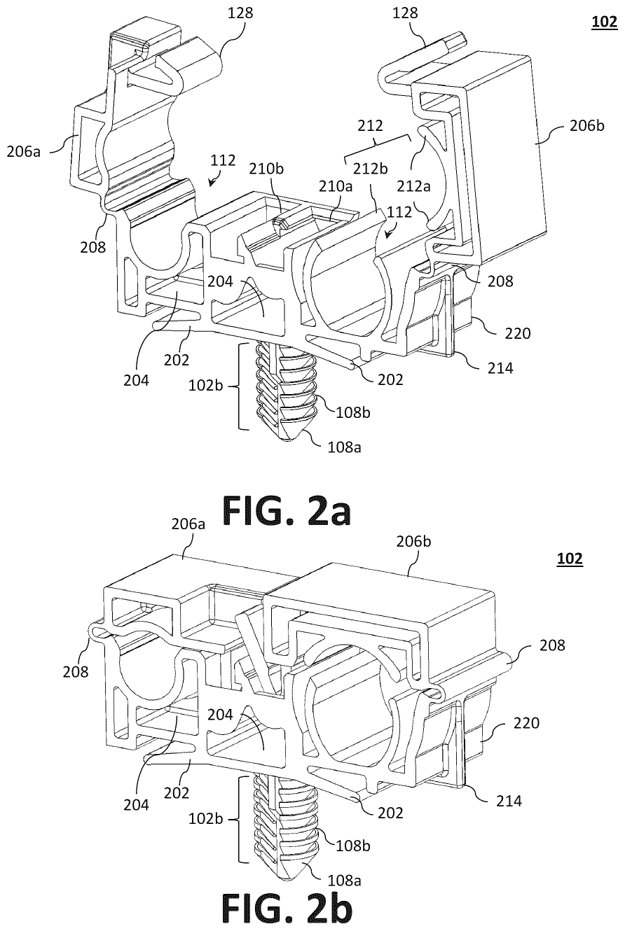

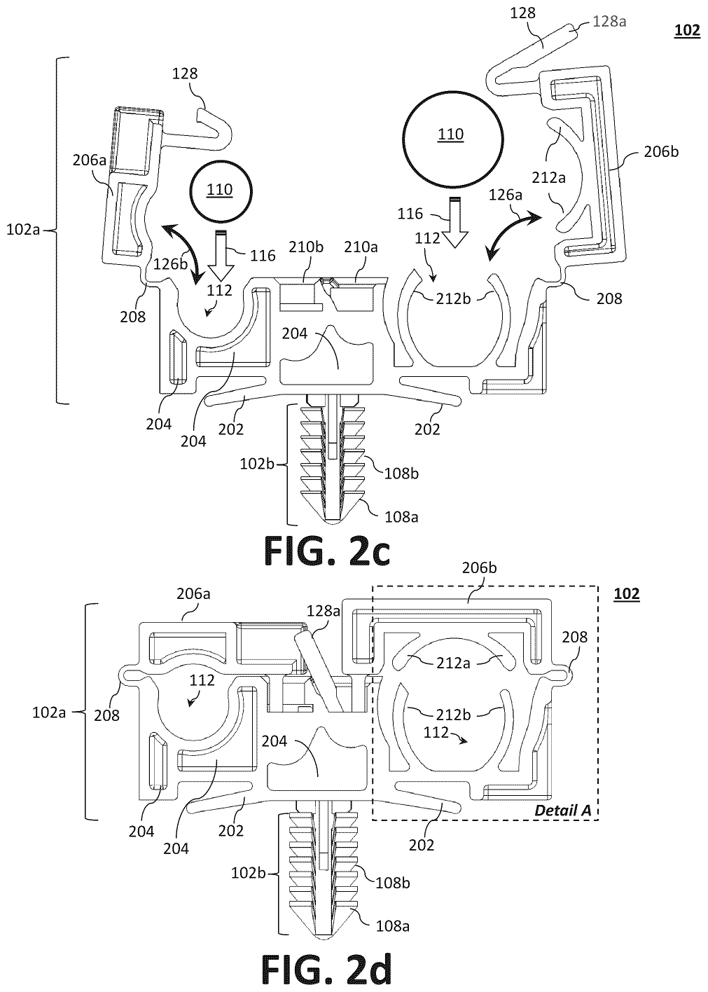

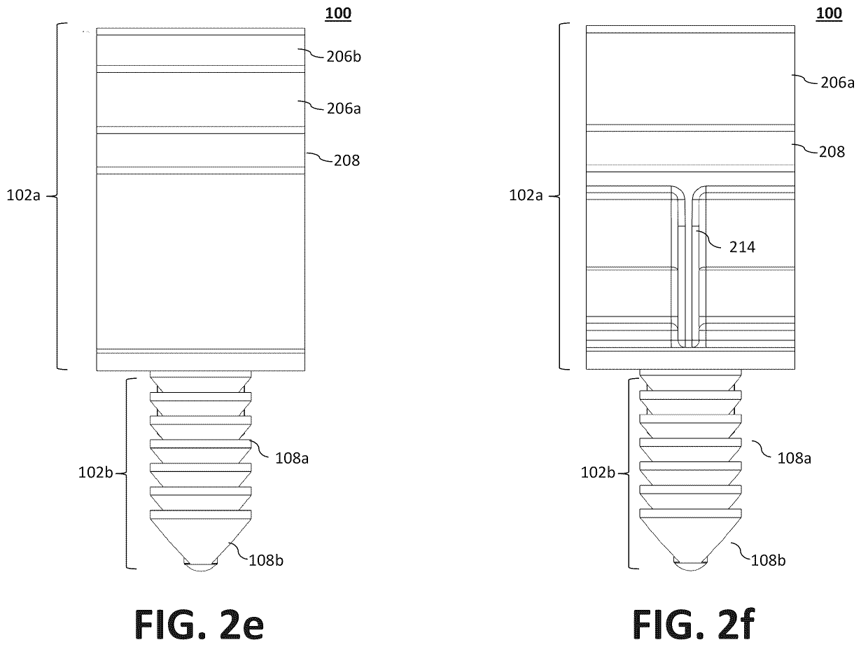

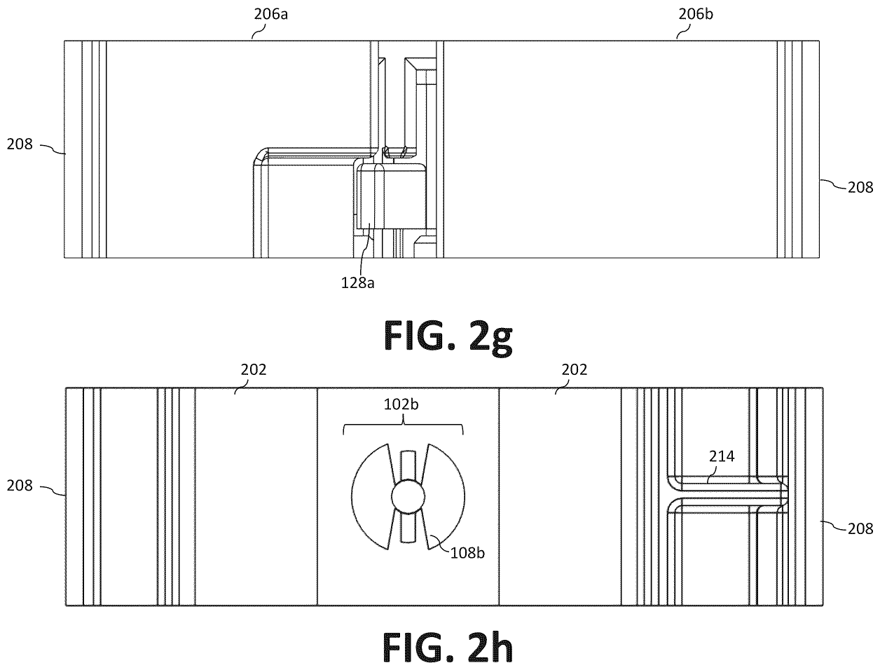

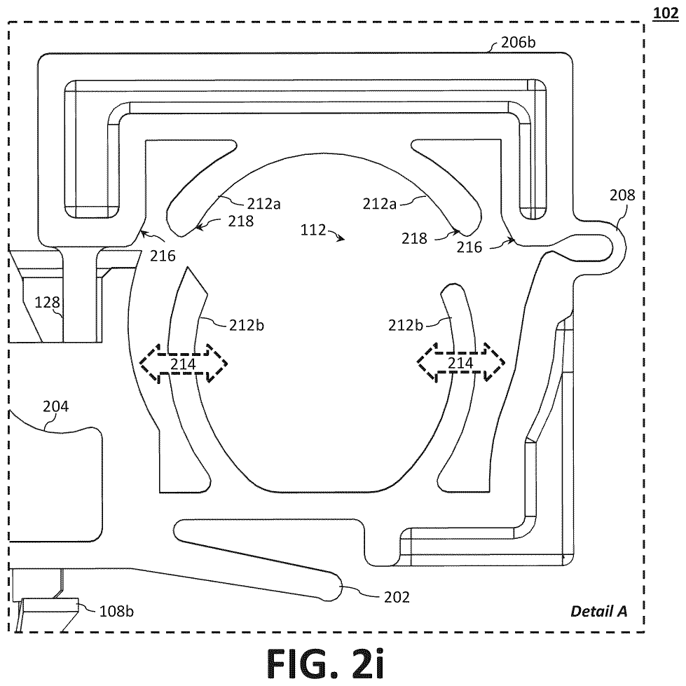

FIGS. 2a and 2b illustrate topside isometric views of the tube retainer 102 of FIGS. 1a and 1b in an open position to facilitate loading of one or more tubes 110 into its respective pocket 112 and a closed position. FIGS. 2c and 2d illustrate side elevation views of the first side of the tube retainer 102 in the open position and the closed position, while FIGS. 2e and 2f illustrate side elevation views of the third side and fourth side of the tube retainer 102 in the closed position, respectively. FIGS. 2g and 2h illustrate top plan and bottom plan views of the tube retainer 102, respectively. FIG. 2i provides a detailed view (i.e., Detail A of FIG. 2d) of the tube retainer 102.

The tube retainer 102 may include, define, or otherwise provide a carrier portion 102a and a fastener portion 102b. The illustrated fastener portion 102b is generally perpendicular to the carrier portion 102a, such that a central longitudinal axis 114 running down the center of the fastener portion 102b is generally perpendicular to a lateral axis 120 running along the carrier portion 102a. In other examples, the central longitudinal axis 114 running down the center of the fastener portion 102b is positioned at other angles transverse to the lateral axis 120. The fastener portion 102b can be integrated with the carrier portion 102a or attached during assembly (e.g., via adhesives, welding, a mechanical coupling, or the like). In the illustrated example, a pair of wings 202 are positioned at or near a junction between the carrier portion 102a and the fastener portion 102b to mitigate wobble and/or buzz, squeak, and rattle (BSR), which can be caused by unintended contact or vibration between the tube retainer 102 and the component 104.

The carrier portion 102a is configured to couple with and/or secure one or more objects (illustrated as tubes 110) relative to one another and, ultimately, to the component 104. The carrier portion 102a is illustrated with a plurality of pockets 112, each of which is configured to secure a tube 110.

The carrier portion 102a includes one or more lids (illustrated as a first lid 206a and a second lid 206b) to secure the one or more tubes 110 within one or more of the plurality of pockets 112. As best illustrated in FIGS. 2a and 2c, each of the lids 206a, 206b can pivot about a hinge 208 between an open position (FIGS. 2a and 2c) and the closed position (FIGS. 2b and 2d) as indicated by arrows 126a, 126b to provide access to one or more of the plurality of pockets 112 during installation of the one or more tubes 110 (or other objects). When in the open position, a tube 110 can be inserted into each of the plurality of pockets 112 by urging the tube 110 toward the respective pocket 112 in the direction indicated by arrow 116. Once the one or more tubes 110 are inserted, the lids 206a, 206b can be pivoted about the hinge 208 to the closed position. A snap 128 is provided at the free end of each of the lids 206a, 206b (e.g., opposite the hinge 208) that is configured to engage corresponding features 210a, 210b formed in or on the carrier body 220 of the carrier portion 102a, such as a recess, opening, or otherwise having a ledge, edge, or other protrusion. In some examples, one or more of the snaps 128 may include a button or tab 128a that a user can manipulate to release the snap 128 from its corresponding feature 210b to open the second lid 206b and remove a tube 110. The button or tab 128a is designed to disengage the snap 128 from its corresponding features 210a, 210b to open the lid 206a or 206b.

In lieu of the lids 206a, 206b, one or more of the plurality of pockets 112 may be shaped to secure the one or more tubes 110 via an interference fit (e.g., via features positioned at the opening to the plurality of pockets 112, such as a ledge, bumps, etc.). While two pockets 112 are illustrated, additional or fewer pockets 112 may be provided depending on the design needs (e.g., the number of tubes 110 that need to be secured). The width of the carrier portion 102a can be adjusted accordingly to accommodate the desired number of pockets 112 and/or tubes 110. In the illustrated example, the two pockets 112 are sized differently and configured to receive different-sized tubes 110.

Each of the plurality of pockets 112 can be shaped as a channel or passageway (when in a closed position, as best illustrated in FIGS. 1a, 1b, 2b, 2d, and 2i) sized to accept the outer diameter of the tubes 110. In some examples, each of the plurality of pockets 112 can be shaped as a channel or passageway with a cross-sectional profile that is circular, oval, quadrilateral, etc. The plurality of pockets 112 provides an inner diameter or width that generally corresponds to the outer size and/or shape of the tubes 110.

With reference to FIGS. 2d and 2i, the pocket 112 positioned on the right and associated with the second lid 206b includes two sets of flexible arms, designated as a first set of flexible arms 212a and a second set of flexible arms 212b. The first set of flexible arms 212a, illustrated as an upper set, is formed on the interior surface of the second lid 206b. The second set of flexible arms 212b, illustrated as a lower set, is formed on the interior surface of the pockets 112 formed by the carrier portion 102a. Each set of flexible arms 212a and 212b features a generally C-shaped cross-section with two inward-curving arms extending from a central base portion. For example, each of the two inward-curving arms can be connected to the carrier portion 102a and each other at its respective proximal ends whereas the distal, free ends flare outwardly and define a cavity to receive or at least partially surround the tube 110. The inner surfaces of the arms may include retention features such as ridges or grooves to increase friction and prevent slippage.

The flexible arms 212a and 212b are configured to flex inward and outward, as indicated by arrows 214 in FIG. 2i, allowing the arms to accommodate tubes 110 of different diameters. When a tube 110 is inserted, the arms flex outward to receive the tube and then snap back into place, ensuring a firm grip. The flexible arms 212a and 212b are configured to interfere with each other or with the sides of the second lid 206b and carrier body 220, or both, creating a cam-like force on the tube retainer. This interference generates a force on the tube, increasing the sliding force and ensuring a secure hold.

In other words, the flexibility of the retainers allows the second set of flexible arms 212b to interfere (e.g., abut or otherwise make contact) with the lid at a first location 216 when a large tube 110 is installed and at a second location 218 when a small tube 110 is installed. The first location 216 is positioned on the main body of the lid, while the second location 218 is positioned at the free ends of the first set of flexible arms 212a. The dimensions of the flexible arms 212a and 212b can be tailored to match the specific outer diameter of the tube 110, ensuring a secure fit regardless of the tube size.

The fastener portion 102b of the illustrated tube retainer 102 serves to couple the carrier portion 102a to the component 104. As illustrated, the fastener portion 102b is generally perpendicular to the carrier portion 102a such that a central longitudinal axis 114 runs down the center of the fastener portion 102b. The fastener portion 102b is illustrated as a push-pin assembly (sometimes called trees, pine trees, Christmas trees, etc.) that comprises a plurality of fins 108b distributed or otherwise arranged along the length of the fastener body 108a of the fastener portion 102b. The leading end of the fastener portion 102b (e.g., the tip of the fastener body 108a) can be rounded, tapered, or otherwise shaped to increase ease of insertion into the opening 106 by helping to align and guide the fastener portion 102b into the opening 106.

The fins 108b may be shaped as blades, teeth, barbs, or the like. As illustrated, the fins 108b are angled away from the central longitudinal axis 114 and are configured to deflect inward toward the central longitudinal axis 114 as the fastener portion 102b is passed through the opening 106 in the component 104. The fins 108b are angled upwardly relative to the central longitudinal axis 114 (forming an acute angle between each fin 108b and the central longitudinal axis 114) to resist pullout forces. To form the connection with the component 104, the fastener portion 102b of the tube retainer 102 is inserted into an opening 106 formed in or on a surface of the component 104 as indicated by the arrow 118. In some examples, the fastener portion 102b can extend beyond the component 104 to exit and protrude from the B-side surface 104b as best illustrated in FIG. 1b.

The tube retainer 102 may be formed as a unitary structure. In one example, the tube retainer 102 can be fabricated via mold tooling and a plastic-injection molding process. In another example, the tube retainer 102 can be a printed thermoplastic material component that can be printed with great accuracy and with numerous details, which is particularly advantageous, for example, in creating components requiring complex and/or precise features. In addition, additive manufacturing techniques obviate the need for mold tooling typically associated with plastic injection molding, thereby lowering up-front manufacturing costs, which is particularly advantageous in low-volume productions. In some examples, the tube retainer 102 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process.

Additive manufacturing techniques print objects in three dimensions, therefore both the minimum feature size (i.e., resolution) of the X-Y plane (horizontal resolution) and the layer height in Z-axis (vertical resolution) are considered in overall printer resolution. Horizontal resolution is the smallest movement the printer's extruder can make within a layer on the X and the Y axis, while vertical resolution is the minimal thickness of a layer that the printer produces in one pass. Printer resolution describes layer thickness and X-Y resolution in dots per inch (DPI) or micrometers (μm). The particles (3D dots) in the horizontal resolution can be around 50 to 100 μm (510 to 250 DPI) in diameter. Typical layer thickness (vertical resolution) is around 100 μm (250 DPI), although the layers may be as thin as 16 μm (1,600 DPI). The smaller the particles, the higher the horizontal resolution (i.e., higher the details the printer produces). Similarly, the smaller the layer thickness in Z-axis, the higher the vertical resolution (i.e., the smoother the printed surface will be). A printing process in a higher vertical resolution printing, however, will take longer to produce finer layers as the printer has to produce more layers. In some examples, the tube retainer 102 may be formed or otherwise fabricated at different resolutions during a printing operation. For example, the carrier portion 102a (or portions thereof) may be printed at a lower resolution than that of the fastener portion 102b or vice versa as needed for a particular application.

While it is contemplated that all portions of the tube retainer 102 would be formed during the same printing session (i.e., printed during the same printing operation), it is possible that the tube retainer 102 may be printed in two sessions. For example, the carrier portion 102a may be printed with one or more landmark structures (e.g., a protrusion or a recess) during a first session that can be located and filled and/or surrounded with material during a second session to form the fastener portion 102b.

In some examples, the tube retainer 102 comprises one or more windows 204 (e.g., recesses, cut outs, or openings) formed in or on a carrier body 220 of the carrier portion 102a and/or the fastener portion 102b. The one or more windows 204 can serve to reduce the amount of material needed to fabricate the tube retainer 102, thus reducing material cost and part weight. The leading end can be rounded, tapered, or otherwise shaped to increase insertion ease of the opening 106.

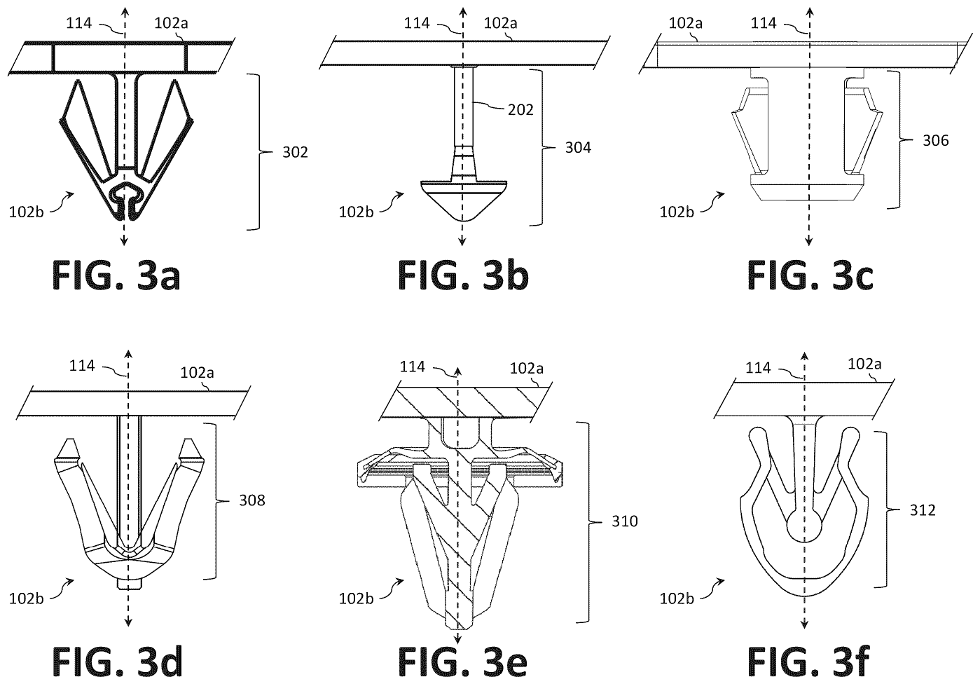

While the fastener portion 102b is illustrated in the figures as a push-pin fastener, other fastener designs are contemplated. For example, FIGS. 3a through 3f illustrate additional fastener styles that can be used as the fastener portions 102b suitable for coupling the carrier portion 102a with the component 104. Specifically, FIGS. 3a through 3f illustrate, respectively, a W-shaped clip fastener 302 (illustrated as a 2-legged clip fastener), pin fastener 304, a box-prong fastener 306 (illustrated as a 2-legged box-prong fastener), a specialty clip assembly 308 (e.g., a CenterLok™ fastener, which is available from Deltar®), a clip assembly with four retaining legs 310, and an clip assembly with two snap-engaging seats 312. The clip assembly with four retaining legs 310, which is illustrated in FIG. 3e as a cross-sectional view, is further described in connection with commonly owned U.S. Pat. No. 10,385,901 to Jeffrey J. Steltz. The clip assembly with two snap-engaging seats 312 of FIG. 3f is further described in connection with commonly owned U.S. Pat. No. 10,018,214 to Fulvio Pacifico Yon.

The above-cited patents and patent publications are hereby incorporated by reference in their entirety. Where a definition or the usage of a term in a reference that is incorporated by reference herein is inconsistent or contrary to the definition or understanding of that term as provided herein, the meaning of the term provided herein governs and the definition of that term in the reference does not necessarily apply.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A tube retainer for securing a tube relative to a component, the tube retainer comprising:
a carrier portion configured to secure the tube via a tube pocket,
wherein the carrier portion comprises a carrier body and a lid coupled to the carrier body via a hinge, and
wherein the tube pocket comprises a first set of flexible arms positioned on the carrier body and a second set of flexible arms positioned on the lid; and
a fastener portion defining a central longitudinal axis, wherein the fastener portion is configured to engage the component via an opening.

2. The tube retainer of claim 1, wherein the lid comprises a snap configured to engage a corresponding feature formed in or on the carrier body, and wherein the snap comprises a button configured to disengage the snap from the corresponding feature.

3. A tube retainer for securing a tube relative to a component, the tube retainer comprising:
a carrier portion configured to secure the tube via a tube pocket, wherein the tube pocket comprises a first set of flexible arms and a second set of flexible arms; and
a fastener portion defining a central longitudinal axis, wherein the fastener portion is configured to engage the component via an opening.

4. The tube retainer of claim 3, wherein each of the first set of flexible arms and the second set of flexible arms comprises two inward-curving arms.

5. The tube retainer of claim 3, wherein each of the first set of flexible arms and the second set of flexible arms defines a C-shaped cross-section.

6. The tube retainer of claim 3, wherein the carrier portion comprises a carrier body and a lid coupled to the carrier body via a hinge, and wherein the first set of flexible arms is positioned on the carrier body and the second set of flexible arms is positioned on the lid.

7. A tube retainer for securing a tube relative to a component, the tube retainer comprising:
a carrier portion configured to secure the tube via a tube pocket, wherein the tube pocket comprises a first set of flexible arms that comprises two inward-curving arms; and
a fastener portion defining a central longitudinal axis, wherein the fastener portion is configured to engage the component via an opening.

8. The tube retainer of claim 7, wherein the two inward-curving arms are configured to flex towards and away from one another.

9. The tube retainer of claim 7, wherein the two inward-curving arms define a C-shaped cross-section.

10. The tube retainer of claim 7, wherein the tube pocket comprises a second set of flexible arms.

11. The tube retainer of claim 10, wherein the second set of flexible arms comprises two inward-curving arms.

12. The tube retainer of claim 7, wherein the carrier portion comprises a carrier body and a lid coupled to the carrier body via a hinge.

13. The tube retainer of claim 12, wherein the first set of flexible arms is positioned on the carrier body and a second set of flexible arms is positioned on the lid.

14. The tube retainer of claim 7, wherein the carrier portion comprises a second set of flexible arms opposite the first set of flexible arms.

15. The tube retainer of claim 7, wherein the carrier portion and the fastener portion are fabricated as a unitary structure.

16. The tube retainer of claim 12, wherein the carrier body, the lid, and the hinge are fabricated as a unitary structure.

17. The tube retainer of claim 12, wherein the lid comprises a snap configured to engage a corresponding feature formed in or on the carrier body.

18. The tube retainer of claim 17, wherein the snap comprises a button configured to disengage the snap from the corresponding feature.

19. The tube retainer of claim 7, wherein the carrier portion includes a carrier body that defines one or more windows.

20. The tube retainer of claim 7, wherein the fastener portion comprises a plurality of fins distributed along the central longitudinal axis to define a fin tier.
